(19) United States
(12) Patent Application Publication
(10) Pub. No.: US 2025/0060209 A1
(43) Pub. Date: Feb. 20, 2025

(54) METHOD FOR COMPENSATING ANGULAR ERRORS

(71) Applicant: TDK-Micronas GmbH, Freiburg (DE)

(72) Inventors: Joerg FRANKE, Freiburg (DE); Johannes GUTMANN, Staufen (DE)

(73) Assignee: TDK-Micronas GmbH, Freiburg (DE)

(21) Appl. No.: 18/806,329

(22) Filed: Aug. 15, 2024

(30) Foreign Application Priority Data
Aug. 15, 2023 (DE) 10 2023 003 365.0

(51) Int. Cl. G01B 7/30; G01D 5/14; G01D 5/16

(52) U.S. Cl. CPC G01B 7/30; G01D 5/145; G01D 5/16

(57) ABSTRACT

A method for compensating angular errors when determining angular values of an arrangement with a permanent magnet and at least two magnetic field sensors. An evaluation signal corresponding to the angular values is formed from the two signals using an arc tangent function. Arrangement errors and errors of a measurement and evaluation unit change the shape of the evaluation signal and lead to an angular deviation in the evaluation signal. In order to minimize the angular deviation, values for correcting gain errors and/or values for correcting orthogonality errors of the signals are changed and values for the gain errors and/or values for correcting orthogonality errors are ascertained by determining a second harmonic in the evaluation signal and/or a third harmonic in the signals and/or density differences of measurement points of a Lissajous curve.

This nonprovisional application claims priority under 35 U.S.C. § 119 (a) to German Patent Application No. 10 2023 003 365.0, which was filed in Germany on Aug. 15, 2023, and which is herein incorporated by reference.

### BACKGROUND OF THE INVENTION

### Field of the Invention

The invention relates to a method for compensating for angular errors.

### Description of the Background Art

A method is known from DE 10 2014 109 693 A1, which corresponds to US2016/0011010, which is incorporated herein by reference, and in which an angular position of a magnetic device with an axis of rotation is determined using non-contact measurement. In this case, the magnetic device has one magnet and at least three magnetic field sensors, wherein a sine and a cosine output signal is calculated from the signals of the magnetic field sensors by a transform.

From the two output signals, or from the instantaneous values of the two output signals, the angle of rotation, i.e., the angular position of the magnet or sensor arranged on the axis of rotation, is calculated directly in an evaluation device by an arc tangent function.

By using at least three magnetic field sensors, magnetic interference fields can be compensated, wherein interference fields occur especially in the field of application of automotive electronics. The device and the method are not limited to three magnetic field sensors. If more than three sensors are used, the angular position can be calculated more accurately.

However, conventional methods are not suitable to compensate for errors caused by positioning and positional inaccuracies. For example, both magnet and sensor devices can be axially offset from each other by tolerances or have an inclination or tilt.

Further errors in the signals and consequently in the determination of angles are caused by non-ideal magnetic properties and temperature fluctuations and aging, in particular. Basically, the errors can be divided into three classes: Offset errors, causing the signals to have DC components, and Gain errors, causing deviations in the peak values of the amplitudes of the signals, and Orthogonality errors, causing deviations in the phase shift of the two signals.

From the “Application Note APN000202_001EN”, further methods for compensating for these errors are known. The underlying devices have means to carry out compensation processes.

However, due to the variety of error sources and the superposition of error sources, such as an axial misalignment between the magnet and sensor device in conjunction with a tilt of the magnet, effects occur that cannot be corrected using the compensation methods mentioned.

### SUMMARY OF THE INVENTION

It is therefore an object of the invention to provide a method which further develops the state of the art.

According to the subject matter, a method for compensating angular errors is provided.

The method is performed to determine angular values of an arrangement with a permanent magnet and at least two magnetic field sensors.

The two magnetic field sensors can be connected to a measurement and evaluation device.

There is a distance between the permanent magnet and the magnetic field sensors.

Using a forcibly guided mechanical movement, a sine signal and a cosine signal are generated in the magnetic field sensors, or the sine signal and the cosine signal are generated by a transform.

From the two signals, an evaluation signal corresponding to the angular values is formed using an arc tangent function, wherein arrangement errors and errors from the measurement and evaluation unit change the shape of the evaluation signal.

In the evaluation signal, the errors lead to angular deviation, wherein values for correcting gain errors and/or values for correcting orthogonality errors in the signals are changed in order to minimize angular deviation.

In a single method step, the correction values for gain and/or orthogonality are ascertained by determining a second harmonic for the evaluation signal and/or a third harmonic for the signals and/or density differences of measurement points of a Lissajous curve.

It should be noted that the measurement and evaluation unit generally does not determine the values for the correction of gain errors and/or values for the correction of orthogonality errors but applies values for the correction of gain errors and/or values for the correction of orthogonality errors which have in particular already been determined during a calibration, for example. The latter tends to take place outside the measurement and evaluation unit and is generally stored.

In other words, in particular, gain errors, i.e., amplitude differences of signals, and/or orthogonality errors, i.e., a deviation of 90 degrees in the phase relationship between two signals, are known before the method is carried out and are taken into account by the measurement and evaluation unit, i.e., the signals are corrected accordingly.

It should be noted that in contrast to the prior art, in which, for example, the minimum and maximum values of the signals are considered, whereby the resulting angular deviation is in some cases even increased instead of reduced, in the present invention the values for correcting gain errors and/or values for correcting orthogonality errors are determined by a different method in order to reliably correct second-order angular deviations.

It is understood that the term “magnetic field sensors” includes, for example, vertical Hall sensors and/or lateral Hall sensors and/or TMR and/or AMR and/or other types of sensors. In addition, different types of magnetic field sensors can also be used in the arrangement.

It should be noted that the sine signal and the cosine signal can be derived directly as measurement signals from the two magnetic field sensors even in a design with only exactly two sensors, or only by a transform of the measurement signals. Especially if there are more than two magnetic field sensors, the sine signal and the cosine signal can normally only be generated by a transform. Even with exactly two magnetic field sensors, depending on the arrangement of the two magnetic field sensors and/or when using different types of magnetic field sensors—for example, one of the two magnetic field sensors may be designed as a TMR and the other as a Hall sensor—a transform may be necessary.

It should be noted that in a run from 0° to 360°, the measurement points in the Lissajous curve basically lie on a closed curve, wherein in the case that the arrangement has no interference, the curve has a constant radius and the measurement points are evenly distributed on the circular line. In other words, the curve is a circle.

If there is interference, the radius is no longer constant and the curve deviates from a circle and/or the distribution of points on the Lissajous curve is different.

It should be noted that in general, the method minimizes the third harmonic in the signals by changing values for correcting any gain errors and/or values for correcting any orthogonality errors.

The third harmonic can be determined directly in the signals or in the resulting effects, such as the resulting angular deviation of the evaluation signals as the second harmonic or the density differences in the Lissajous curve of the two signals.

It should be noted that in an alternative, the angular deviation of the evaluation signals can be minimized, which occurs there as the second harmonic. In other words, the second harmonic is minimized.

In another alternative, the density differences are compensated for using the Lissajous curve.

It should be noted that the approaches described above for a reduction of errors are equivalent to each other in terms of effect.

It is understood that error values in the signals can be determined and compared directly and only then the values for correcting the gain errors and/or values for correcting the orthogonality errors are determined using the method according to the invention.

An advantage of the method is that errors from the axial misalignment between the magnet and sensor device or the tilting of the magnet and other causes of errors that cause higher-order effects in the signals can be compensated.

In particular, a third harmonic can be determined in the sine and cosine signals, which occurs as the second harmonic in the resulting deviation of the angle of rotation. It goes without saying that it is advantageous to examine at least a 360° run.

Furthermore, it should be noted that the method significantly expands the compensation for angular errors, which occur as third harmonics of the signals.

This increases the achievable precision of the angular measurement on the one hand, and on the other hand reduces the requirements for manufacturing tolerances and reduces the yield or effort involved in assembling the device. In other words, costs in production can be reduced.

It is understood that the method is not limited to rotation angle measurement. The method can be used for all forms of non-contact displacement measurement, in which at least one permanent magnet in conjunction with at least two magnetic field sensors generates a sine and cosine signal. This includes in particular any kind of linear motion of which the magnetic structure is designed in an appropriate manner.

In an example, after calculating the angular values using the arc tangent function, the values for correcting gain errors and/or values for correcting orthogonality errors can be determined from the second harmonic of the resulting angular deviation of a 360° revolution.

In order to determine the values for correcting gain errors and/or values for correcting orthogonality errors from the density differences of the Lissajous curve, the measurement points can be recorded at a more constant period velocity/frequency or rotation speed with a fixed sampling rate.

The values for correcting gain errors and/or values for correcting orthogonality errors can be determined from the proportion of the second harmonic calculated using DFT or FFT in the resulting course of the error of the angle of rotation of a 360° revolution.

The values for correcting gain errors and/or values for correcting orthogonality errors can be determined from the change in correction values already generated by other methods in conjunction with the third harmonic, calculated using DFT or FFT, of the sine and cosine signals. In other words, by means of the method according to the invention, after correction, the gain errors in the signals are calculated from the determination of the third harmonic and/or values for correcting orthogonality errors are calculated from the determination of the second harmonic.

The DFT calculation can be carried out using a Goertzel algorithm or, in an alternative, the second harmonic or the third harmonic is determined directly using sine adaptation, also known as sine fitting. In other words, in the alternative, exactly no FFT or DFT calculation is performed. An advantage is that the computing power is reduced.

The values for correcting gain errors and/or values for correcting orthogonality errors can be determined several times, in an iterative manner. This can further increase the accuracy of the angle calculation.

After correction values have already been determined, a third harmonic can be determined directly in the signals from a comparison of the course of the signals with an ideal sine wave and from a comparison of the course of the signals with an ideal cosine curve.

From the correction values already determined and the deviation from the ideal courses, the values for correcting gain errors and/or values for correcting orthogonality errors can then be determined.

The method can be used to determine the rotation angle position in an arrangement with permanent magnets and magnetic field sensors.

In this case, the arrangement has an axis with one front side and at least one permanent magnet arranged on the front side or on the side of the axis.

Magnetic field sensors can be arranged along an imaginary extension of the axis. Alternatively, the magnetic field sensors are arranged laterally, i.e., at a distance from the imaginary extension of the axis.

It is understood that there may be a distance between the axis and the magnetic field sensors.

A measurement and evaluation device can be connected to the magnetic field sensors, wherein a sine signal or a cosine signal is generated when the axis is rotated at an output of the respective magnetic field sensor or is obtained by a transform.

In a further development, the magnetic field sensors can be spaced along an X direction.

The magnetic field sensors can be arranged directly next to each other in the X direction and/or are partially or completely arranged on top of each other in a Z direction.

Three magnetic field sensors can each be arranged in the shape of a pixel cell, wherein three different directions of a magnetic field are measured by the three magnetic field sensors. Several magnetic field sensors can be arranged on an X-Y plane, preferably linearly or on a circle.

The measurement and evaluation device can be set up to calculate an evaluation signal corresponding to the rotation angle values from the signals using an arc tangent function.

Furthermore, the measurement and evaluation device can be set up to calculate values for correcting gain errors and/or values for correcting orthogonality errors for a change in the evaluation signal in order to minimize the angular deviation.

In an alternative version, the method can be used in a different arrangement for the determination of angular values of a translational motion path.

In this case, the other arrangement comprises a large number of permanent magnet pairs arranged along the translational path and at least two magnetic field sensors arranged along the translational motion path.

The magnetic field sensors can be spaced apart from the permanent magnet pairs, arranged relative to each other and movable along the translational motion path.

Furthermore, a measurement and evaluation device connected to the magnetic field sensors can be provided.

In the case of a translational movement of the permanent magnet pairs or the magnetic field sensors along the path, a sine signal or a cosine signal can be present at an output of the respective magnetic field sensor or these are obtained by a transform.

The measurement and evaluation device can be set up to calculate an evaluation signal from the signals which corresponds to the angular values using an arc tangent function.

Furthermore, the measurement and evaluation device can be set up to calculate values for correcting gain errors and/or values for correcting orthogonality errors for a change in the evaluation signal in order to minimize the angular deviation.

The measurement and evaluation device can be set up to determine values for correcting gain errors and/or values for correcting orthogonality errors using a DFT or FFT evaluation.

The measurement and evaluation device can include a Goertzel filter or the measurement and evaluation device is set up to perform sine fitting.

The measurement and evaluation device can be set up to determine the density differences of a Lissajous curve.

The measurement and evaluation device with the magnetic field sensors can be integrated into an IC housing, monolithically or as a multi-chip solution.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows sine signals and cosine signals that are flawed due to a third harmonic;

FIG. 2 shows a spectrum of the signals;

FIG. 3 shows a representation of the resulting angular error of the evaluation signal,

FIG. 4 shows a spectrum of the evaluation signal;

FIG. 5 shows a representation of flawed sine and cosine signals in a Lissajous curve with density differences of the measurement points;

FIG. 6 shows faulty sine and cosine signals;

FIG. 7 shows a Goertzel filter;

FIG. 8 shows a rotary device;

FIG. 9 shows a linear device; and

FIG. 10 shows a representation of ideal sine and cosine signals.

### DETAILED DESCRIPTION

It should be noted that in the following figures, the depicted sine and cosine signals from the two magnetic field sensors S1 and S2 are either directly available as measurement signals or only after a transform.

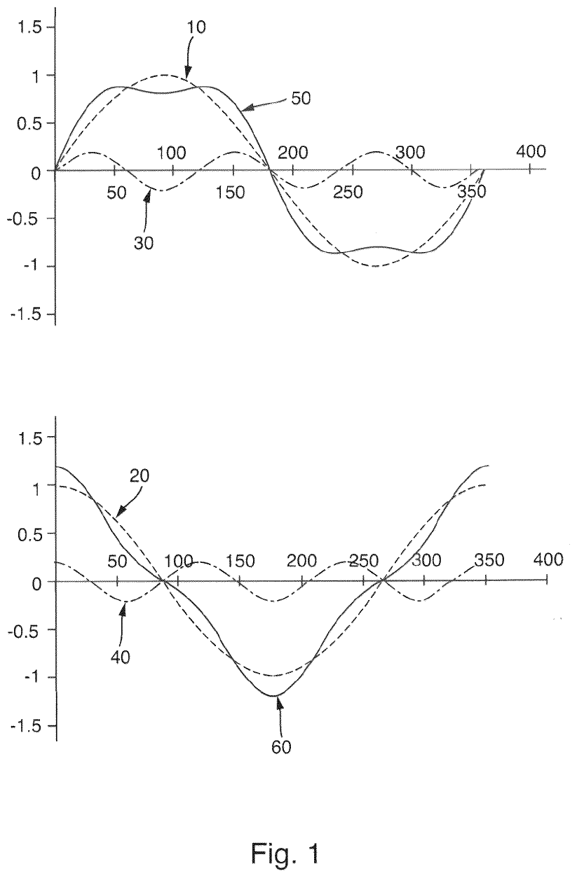

FIG. 1 shows an ideal sine signal 10 and an ideal cosine signal 20, which respectively represent the first harmonic of the two signals 10 and 20. On the abscissa, the applied angular value is given in degrees and on the ordinate, the magnitude of the output signal, wherein the maximum amplitude is normalized to the value 1.

A sine error signal 30 and a cosine error signal 40 occur with three times the frequency and thus represent a third harmonic in relation to the two ideal signals 10 and 20.

The curve progressions 50 and 60 show the actual signals, wherein actual signals are distorted by a superposition of the ideal signals 10 and 20 with the error signals 30 and 40.

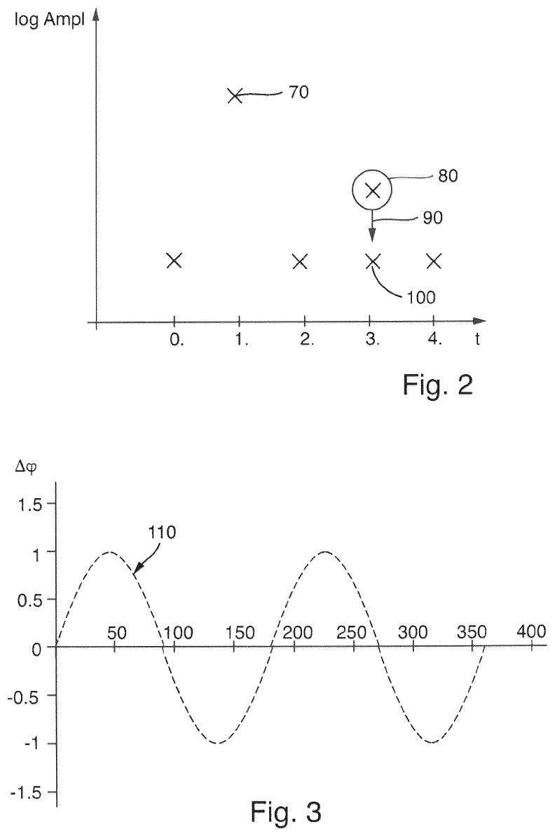

FIG. 2 shows a spectrum of the signals 50 and 60.

The frequency is plotted on the abscissa; on the ordinate, the logarithmically scaled amplitude of the signals.

The amplitude of the first harmonic 70, which is also called the fundamental frequency, and the amplitude of the third harmonic 80, which is also called the second harmonic, are correspondingly strong.

The application of the method according to the invention causes a reduction 90 of the third harmonic 80 to a significantly lower level 100.

FIG. 3 shows the curve progression of the resulting angular error delta Phi, which appears as the second harmonic 110.

The actual angle value in degrees of the magnetic arrangement is plotted on the abscissa. On the ordinate, the resulting angular error is plotted in degrees.

In this case, the error occurs as a second harmonic oscillation. The prerequisite for the described characteristic is a deviation of the signals in the form of a pronounced third harmonic.

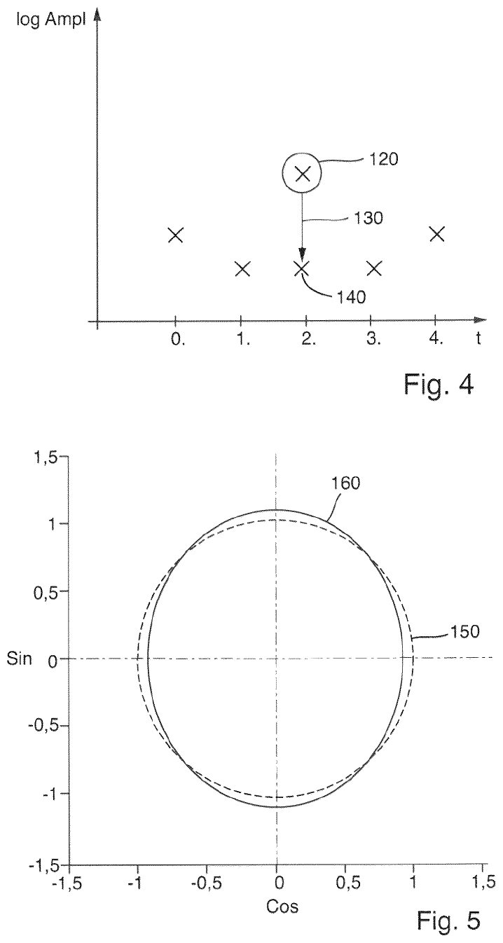

FIG. 4 shows a spectral representation of the resulting angular error Delta Phi. The amplitude of the second harmonic 120 is clearly pronounced.

The application of the method according to the invention causes a reduction 130 of the second harmonic 120 to a significantly lower level 140.

FIG. 5 shows a Lissajous curve of sine and cosine measurement signals.

The curve is not further deformed, which means that the three errors in question are already ideally resolved. However, the curve does not have equidistant measurement points 8.

The density distribution is an indication of the occurrence of a second harmonic in the signals. Changing the values for correcting gain errors and/or values for correcting orthogonality errors distorts the curve but homogenizes the density distribution and reduces the resulting angular error Delta Phi.

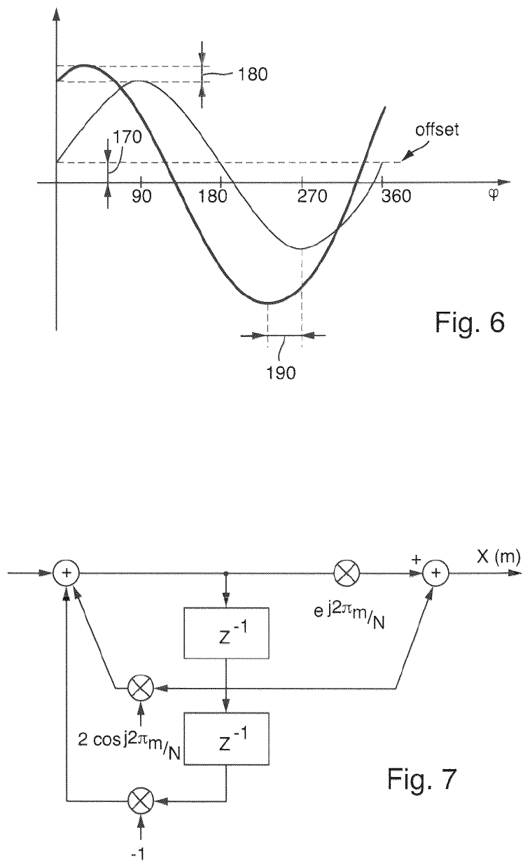

FIG. 6 shows the curve progression of the uncompensated sine and cosine signals as a function of the rotation angle value actually applied by the magnetic device.

The signals have three types of errors, the compensation for which forms the state of the art. A DC component 170, often referred to as an offset, causes a modulation of one or both signals in the positive or negative direction.

A gain error 180 results in a difference in the peak values of the two signals without DC component.

An orthogonality error 190 leads to a phase shift unequal to 90° in the signals. Here, the orthogonality error describes the deviation of the two measured magnetic field vector components from an ideal 90° orientation.

The application of the method of the invention reduces the amplitude of the third harmonics in the measured values by correcting the values for compensating for gain errors and/or the values for compensating for orthogonality errors and thereby also minimizes the resulting angular error Delta Phi.

It is intrinsic to the method that in the case of a third harmonic in the signals, an increased gain error and/or an increased orthogonality error leads to a smaller resulting angular error than in a known compensation in which a gain error and/or an orthogonality error in the signals is immediately resolved.

This can be referred to as overcompensation. In other words, using the method of the invention, the overcompensation of the gain error and/or the orthogonality error from the first harmonic of the signals leads to an increase in the accuracy of the angular calculation.

In the illustration of FIG. 7, a second-order Goertzel filter is shown as an example. The use of the Goertzel filter allows for the targeted determination of individual spectral components of a signal. The Goertzel filter is particularly suitable for the determination of the third harmonic of the signals according to the invention.

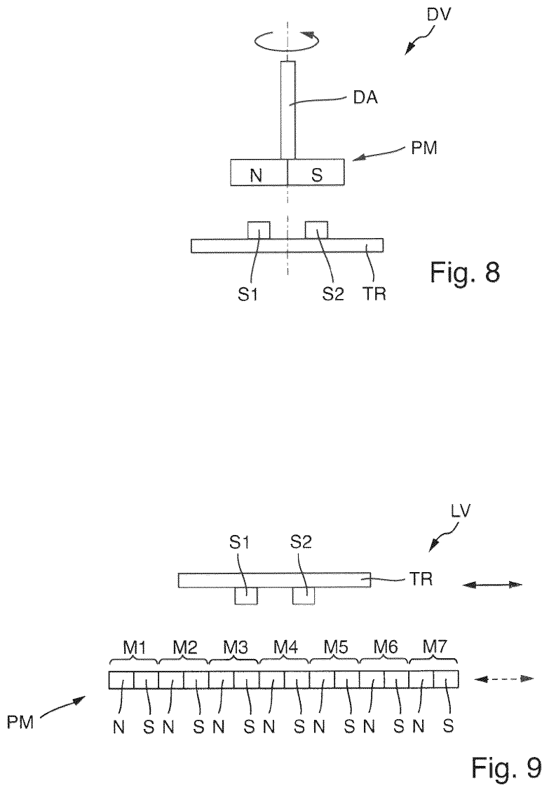

FIG. 8 shows a rotary device DV, wherein the rotary device DV has an axis of rotation DA formed in a Z direction and a permanent magnet PM arranged at a front end of the axis of rotation DA on an X-Y plane. The permanent magnet PM has a north pole N and a south pole S. Along an imaginary extension of the axis of rotation DA, a first magnetic field sensor S1 and a second magnetic field sensor S2 are arranged on a carrier board TR.

The two magnetic field sensors S1, S2 are spaced apart in an X direction by a distance x1. Both magnetic field sensors S1, S2 are also spaced from the head end of the axis of rotation DA. In the event the carrier board with the two magnetic field sensors S1, S2 tilts in relation to the front end and or the magnetic field sensors S1, S2 are misaligned, the signals are subjected to different errors.

In an embodiment not shown, the distance x1 between the two magnetic field sensors S1 and S2 is zero or very small, so that the two magnetic field sensors S1 and S2 are arranged on top of each other in the Z direction, wherein the two magnetic field sensors preferably measure different components of the magnetic field when arranged on top of each other.

FIG. 9 shows an arrangement of pairs of a permanent magnet along a straight line.

Using the linearly movable permanent magnet PM, which has the pole pairs M1-M7 lined up next to each other, a sine and a cosine signal can be generated by the spaced magnetic field sensors S1, S2. The linear motion also enables the inventive compensation for angular errors due to third-order deviations in the signals, which can also be applied to translational displacement/position measurement [sic].

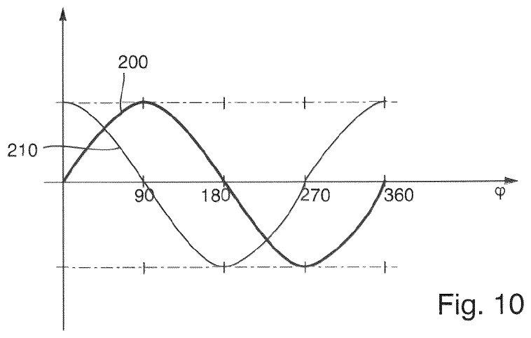

FIG. 10 shows an ideal progression of the two signals with a sine signal 200 and a cosine signal 210 as a function of the rotation angle value actually applied by the magnetic device.

By evaluating the arc tangent function, the rotation angle value is determined from the quotient of the signals.

Both the sine signal and the cosine signal are ideal, i.e., free of errors.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for compensating angular errors when determining angular values of an arrangement comprising a permanent magnet and at least two magnetic field sensors, the method comprising:
connecting a measurement and evaluation device to the at least two magnetic field sensors;
forming a distance between the permanent magnet and the magnetic field sensors;
generating a sine signal and a cosine signal using a forcibly guided mechanical movement in the magnetic field sensors or the sine signal and the cosine signal generated by a transform, and an evaluation signal corresponding to the angular values formed from the two signals using an arc tangent function;
changing a shape, via arrangement errors and errors of the measurement and evaluation unit, of the evaluation signal and lead to an angular deviation in the evaluation signal;
changing gain values and orthogonality values of the signals in order to minimize angular deviation; and
ascertaining values for correcting gain errors and/or values for correcting orthogonality errors by determining a second harmonic for the evaluation signal and/or a third harmonic for the signals and/or density differences of measurement points of a Lissajous curve.

2. The method according to claim 1, wherein after calculating the angular values using the arc tangent function, the values for correcting the gain errors and/or values for correcting the orthogonality errors are determined from the amplitude and phase of the second harmonic of the resulting angular deviation of a 360° revolution.

3. The method according to claim 1, wherein for the purpose of determining the values of gain errors and/or values for correcting orthogonality errors from the density differences of the measurement points of the Lissajous curve, the measurement points are recorded at a constant rotational speed with a fixed sampling rate.

4. The method according to claim 1, wherein the values for correcting gain errors and/or values for correcting orthogonality errors are determined from the proportion of the second harmonic calculated using DFT or FFT from the course of the error of the angle of rotation of a 360° revolution.

5. The method according to claim 1, wherein the values for correcting gain errors and/or values for correcting orthogonality errors are determined by changing correction values already generated by other methods and the third harmonic of the sine and cosine signals calculated using DFT or FFT.

6. The method according to claim 4, wherein the DFT calculation is performed using a Goertzel algorithm or that the second harmonic or the third harmonic is directly determined by sine fitting.

7. The method according to claim 1, wherein a determination of values for correcting gain errors and/or values for correcting orthogonality errors is carried out several times, in an iterative manner.

8. The method according to claim 1, wherein after determining the correction values, a third harmonic is determined directly in the signals from a comparison of the course of the signals with an ideal sine wave and from a comparison of the course of the signals with an ideal cosine curve, and from the correction values already determined and the deviation from the ideal curves, the values to be set for the correction of the gain errors and/or values for correcting the orthogonality errors are determined.

9. The method according to claim 1, wherein the magnetic field sensors (S1, S2) are spaced along an X direction or the magnetic field sensors (S1, S2) are arranged on top of each other in a Z direction.

10. A method to determine rotation angle values, the method comprising:
arranging at least one permanent magnet at a front end of an axis or on a side of the axis;
arranging at least two magnetic field sensors along an imaginary extension of the axis or magnetic field sensors arranged laterally to the axis, with a distance formed between the axis and the magnetic field sensors;
connecting a measurement and evaluation device to the magnetic field sensors;
rotating the axis such that a sine signal or a cosine signal is present at an output of the respective magnetic field sensor; and
calculating, via the measurement and evaluation device, an evaluation signal corresponding to the rotation angle values from the signals using an arc tangent function in order to minimize the angular deviation.

11. The method according to claim 1, wherein to determine angular values of a translational motion path, the method further comprises:
arranging a large number of permanent magnet pairs along a translational path;
arranging the at least two magnetic field sensors along the translational path of motion, which are spaced from the permanent magnet pairs and arranged movably along the translational path of motion; and
connecting a measurement and evaluation device to the magnetic field sensors,
wherein, in a translational movement of the permanent magnet pairs or the magnetic field sensors along the path, a sine signal or a cosine signal is present at an output of the magnetic field sensors, the measurement and evaluation device is set up to calculate an evaluation signal corresponding to the angular values from the signals using an arc tangent function in order to minimize the angular deviation.

12. The method according to claim 11, wherein the measurement and evaluation device is set up to determine values for the gain errors and/or values for correcting orthogonality errors using a DFT or FFT evaluation.

13. The method according to claim 11, wherein the measurement and evaluation device comprises a Goertzel filter or the measurement and evaluation device is set up to perform sine fitting.

14. The method according to claim 11, wherein the measurement and evaluation device is set up to determine density differences of the measurement points of a Lissajous curve.

15. The method according to claim 1, wherein the measurement and evaluation device with the magnetic field sensors is integrated into an IC housing, monolithically or as a multi-chip solution.
